(19) United States
(12) Patent Application Publication
(10) Pub. No.: US 2026/0015878 A1
(43) Pub. Date: Jan. 15, 2026

(54) PRECAST STRUCTURE HANDLING SYSTEM

(71) Applicant: ONX, INC., Carrollton, TX (US)

(72) Inventors: Ravi Bhat, Austin, TX (US); Pratheep Kumar Rajendran, Austin, TX (US)

(21) Appl. No.: 18/771,015

(22) Filed: Jul. 12, 2024

(51) Int. Cl. E04G 21/16; B66C 1/02

(52) U.S. Cl. CPC E04G 21/161; B66C 1/0243

(57) ABSTRACT

A precast structure handling system includes at least two vertically parallel members having top ends and bottom ends. The top ends are mechanically coupled with a longitudinal rail at a bottom of a horizontal member. The precast structure handling system further includes at least two adjustable gripper units coupled with opposite bottom ends of the at least two vertically parallel members. Each adjustable gripper unit includes a suction pad configured for coupling with a surface of a precast structure based on a pressure difference generated by a vacuum system. The precast structure handling system further includes a control system that controls a plurality of systems to handle the precast structure based on a plurality of settings in alignment with properties of the precast structure.

### FIELD OF THE INVENTION

The embodiments discussed in the present disclosure are generally related to construction technology. In particular, the embodiments discussed are related to a precast structure handling system for use in construction technology.

### BACKGROUND OF THE INVENTION

Existing construction technologies involve one-off (e.g., customized) build-on site approaches in which construction material is brought to the construction site. This has been the traditional methodology and approach for many years but has certain inherent challenges. Such challenges include non-availability of skilled workforce (e.g., manual labor), heavy and expensive on-site machinery, incorrect estimate of completion time of construction projects, delays in delivery of projects, weather, quality, wastage of materials, noise and air pollution, and cost involved in disposal of debris. This approach is also “one-off” and provides no repeatability or scalability leverage. Each building or project is done differently, and results vary widely.

Further, execution of construction projects needs an ensemble of technologies or domains, such as structural integration, civil engineering, mechanical joints, material science, etc. Although there have been significant advancements in construction technologies, due to the above factors, the average cost of construction and the effective cost of owning a house is still high for a majority of aspiring owners.

In order to address the aforesaid shortfalls of these build-on site approaches, usage of precast structures for construction is also commonplace and has been in practice for some time. For example, structures are precast at factories under factory scaling, repeatability, and in-factory conditions, and then delivered to a building site for expeditious on-site assembly. Precast structures are broadly classified into volumetric and non-volumetric types. A volumetric precast structure is understood to persons skilled in the art as one which has a volume defined by a structured enclosure or boundary. A non-volumetric type is one wherein panels and other precast components are stacked or packed together for storage and shipment with minimum space in-between. For some construction sites, for example, remote sites which are in primitive locations or otherwise too difficult to access, or where resources are difficult to acquire, or when weather conditions or environmental restrictions do not permit, construction using precast structures are often the only practical option.

In accordance with a conventional solution, precast structures of volumetric type are able to be lifted using lifting hooks which are embedded in the concrete. Such lifting hooks are able to be manufactured or bought out. The lifting hooks are able to be fixed manually by a steel fixer measuring its exact location before the concrete is poured. Once cured, a lifting equipment with lifting accessories are able to engage with the precast structure from the bottom side. The precast structure is able to be thereafter placed over a turner/tilting equipment to flip the precast structure by 180 degrees. Post flipping, the lifting equipment is able to lift the precast structure from the top side for further handling. In such cases, there is observed a very high process time involved with repeated hooking and unhooking of the structure. Further, additional costs are incurred due to the hooks. As the whole process is manual, there is able to be a high chance that such a type of handling solution is able to cause massive damage to such structures. In accordance with another conventional solution, vacuum lifters is able to be used for handling precast concrete elements, such as wall sections. However, such handling solution is able to be used only when the precast concrete elements are of non-volumetric type and have substantial surface areas relative to their thicknesses. Also, such vacuum lifters apply suction at one side of such precast concrete elements that are solid, thicker, and bigger elements.

However, there remains a need in the art for an improved, automated, and robust precast structure handling system. Alternatively, there lies a need for an improved, intelligent, automated, and robust precast structure handling system that is able to be used for efficiently lifting and flipping hollow and volumetric precast structures using optimal vacuum suction such that no damage is caused to its thin walls.

### SUMMARY OF THE INVENTION

Embodiments for a precast structure handling system in construction technology are disclosed that address at least some of the above challenges and issues.

In a first aspect, the present subject matter is directed to a precast structure handling system that includes at least two vertically parallel members having top ends and bottom ends, the top ends are configured for mechanically coupling with a longitudinal rail at a bottom of a horizontal member. The precast structure handling system further includes at least two adjustable gripper units coupled with opposite bottom ends of the at least two vertically parallel members, each adjustable gripper unit comprising a suction pad configured for coupling with a surface of a precast structure based on a pressure difference generated by a vacuum system. The precast structure handling system further includes a control system configured for controlling a plurality of systems to handle the precast structure based on a plurality of settings in alignment with properties of the precast structure.

In some embodiments, the plurality of systems includes at least the vacuum system and a power system configured for handling the precast structure. The vacuum system is driven by a controller of a lifting system.

In some embodiments, the at least two adjustable gripper units are controlled by the power system based on a width of the precast structure.

In some embodiments, a rotation of the at least two adjustable gripper units is controlled by the power system at a defined angular rotation.

In some embodiments, the at least two vertically parallel members are controlled by the power system to slidably adjust along the longitudinal rail at the bottom of the horizontal member.

In some embodiments, the at least two adjustable gripper units are adaptable to bear a load of the precast structure. A first part of the load is borne by a plurality of friction pads affixed at a surface of the suction pad of each adjustable gripper unit. A second part of the load is borne by a resilient member running along a boundary of the suction pad of each adjustable gripper unit. A load distribution between the plurality of friction pads and the resilient member is based on an elasticity factor of the resilient member.

In some embodiments, a first height of the resilient member that is transversal to a plane of the suction pad is substantially greater than a second height of the plurality of friction pads.

In some embodiments, the precast structure corresponds to a hollow prefabricated volumetric structure.

In some embodiments, the hollow prefabricated volumetric structure is made of fiber reinforced concrete.

In some embodiments, the control system is further configured to receive precast structure data from one or more sources and control, based on the received precast structure data, the at least two vertically parallel members to slidably adjust towards each other by a first calibrated movement along the longitudinal rail according to a width between outer surfaces of opposite walls of the precast structure.

In some embodiments, the control system is further configured to control, based on the received precast structure data, the at least two adjustable gripper units to finely adjust by a second calibrated movement according to the width between the outer surfaces of the opposite walls of the precast structure.

In a second aspect, a precast structure handling method includes receiving, by a control system, precast structure data from one or more sources. The method further includes controlling, by the control system and based on the precast structure data, a first calibrated movement of at least two vertically parallel members and a second calibrated movement of at least two adjustable gripper units attached with the at least two vertically parallel members. The method further includes controlling, by the control system and based on the precast structure data, handling of a precast structure with a plurality of settings in alignment with properties of the precast structure.

In some embodiments, a load distribution of the precast structure between a plurality of friction pads and a resilient member at the at least two adjustable gripper units is based on an elasticity factor of the resilient member.

In some embodiments, a first part of a load of the precast structure is borne by the plurality of friction pads at the at least two adjustable gripper units. A second part of the load is borne by the resilient member at the at least two adjustable gripper units.

In some embodiments, a first height of the resilient member that is transversal to a plane of the suction pad is substantially greater than a second height of the plurality of friction pads.

In some embodiments, the method further includes controlling, by the control system, the second calibrated movement of the at least two adjustable gripper units based on a width of the precast structure.

In some embodiments, the handling of the precast structure includes lifting or lowering of the precast structure gripped by the at least two adjustable gripper units of a precast structure handling system.

In some embodiments, the handling of the precast structure includes rotation of the precast structure gripped by the at least two adjustable gripper units at a defined angular rotation.

In some embodiments, the precast structure corresponds to a hollow prefabricated volumetric structure. The hollow prefabricated volumetric structure is made of fiber reinforced concrete.

In some embodiments, the method further includes controlling, by the control system, the precast structure handling system, the power system connected to the precast structure handling system, and a vacuum system attached with the at least two adjustable gripper units.

### BRIEF DESCRIPTION OF THE DRAWINGS

Further advantages of the invention will become apparent by reference to the detailed description of preferred embodiments when considered in conjunction with the drawings. In the drawings, identical numbers refer to the same or a similar element.

FIG. 1 illustrates a network environment for implementing a precast structure handling system, in accordance with an embodiment.

FIG. 2 illustrates an isometric view of an exemplary precast structure handling system, in accordance with an embodiment.

FIGS. 3A and 3B illustrate different views of suction pads of an adjustable gripper unit, in accordance with an embodiment.

FIGS. 4A to 4C illustrate various views while the precast structure handling system is handling the precast structure, in accordance with an embodiment.

FIG. 5 illustrates a flowchart specifying the steps of a method for precast structure handling system, in accordance with an embodiment.

### DETAILED DESCRIPTION

The following detailed description is presented to enable any person skilled in the art to make and use the invention. For purposes of explanation, specific details are set forth to provide a thorough understanding of the presently claimed invention. However, it will be apparent to one skilled in the art that these specific details are not required to practice the presently claimed invention. Descriptions of specific applications are provided only as representative examples. Various modifications to the preferred embodiments will be readily apparent to one skilled in the art, and the general principles defined herein are able to be applied to other embodiments and applications without departing from the scope of the presently claimed invention. The presently claimed invention is not intended to be limited to the embodiments shown but is to be accorded the widest possible scope consistent with the principles and features disclosed herein.

With modernization in construction-related technologies, there has been a rapid shift from normal customized build on-site construction methodologies to construction using structures, modules or blocks that are able to be precast or built off-site. Now such precast structures, modules or blocks, once transported to the construction site from the factory settings, must be handled very efficiently, optimally, and cautiously so that no damage is caused and at the same time, saves on time and human labor. Current manufacturing technologies fail to address this concern as conventional solutions involve one-sided vacuum lifting of non-volumetric type structures, and also involves multiple repeated process steps, such as hooking up the structures from the top, pulling up the hooked structures, taking them aside, putting them on a manual tilting device and unhooking, tilting them upside down, and so on. The embodiments of the present disclosure address these concerns by providing a robust, economical, automated, and improved handling mechanism that saves handling time and effort, reduces process cycle steps and time, and at the same time improves process speed and throughput.

The disclosed solutions provide at least an improved precast structure handling system that automatically performs settings of the various mechanical, power, and vacuum systems according to the dimensions of the precast structure with minimal human intervention.

The disclosed precast structure handling system further provides robust and highly efficient handling solutions for optimally handling structures, for example, hollow and volumetric precast structures, with wall thickness of the order of 2 inches. Further, various operations, such as lifting and flipping of such precast structures, are performed very precisely by using optimal vacuum suction and hydraulic power such that no damage is caused to its thin walls during the handling process. The disclosed precast structure handling system involves minimal process cycles as compared to conventional systems, hence substantially improves the throughput and turn-around-time for installing each precast structure.

The embodiments of the present disclosure address the above noted concerns and challenges by providing an improved, automated, intelligent, and robust precast structure handling system with reduced number of process steps. The proposed precast structure handling system is able to be used for efficiently lifting and flipping hollow and volumetric precast structures using vacuum suction from two opposite sides of the structure without causing any damage to the thin walls.

Certain terms and phrases have been used throughout the disclosure and will have the following meanings in the context of the ongoing disclosure.

“Precast Structure” refers to a building module prefabricated at a factory under factory scaling, repeatability, and in-factory conditions.

“Hydraulic Unit” refers to a system that uses liquid fluid power to perform work. Hydraulic fluid is pumped to various hydraulic motors and hydraulic cylinders throughout the system and becomes pressurized according to the resistance present. The fluid is controlled directly or automatically by control valves and distributed through hoses, tubes, or pipes.

“Suction Pads” are used to grip and move workpieces based on a pressure difference created by connecting the suction pad to a vacuum system. As a result, air from the space between the suction pad and the workpiece is evacuated, the ambient air pressure exceeds the pressure between the suction pad and the workpiece, and the suction pads are pressed against the workpiece. When the suction pad is in contact with the surface of the workpiece, no air is able to enter from the sides and a vacuum is generated.

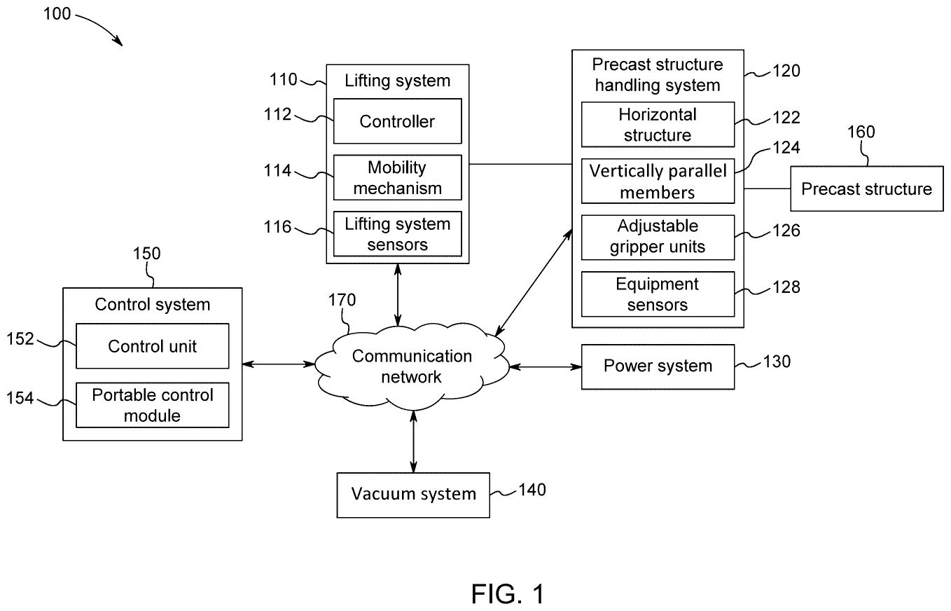

FIG. 1 illustrates a network environment for implementing a precast structure handling system in accordance with some embodiments. As such, FIG. 1 illustrates a network environment 100 in construction technology in accordance with some embodiments of the present disclosure. As shown in FIG. 1, the network environment 100 is able to include a lifting system 110 that is able to further include a controller 112 and a mobility mechanism 114. The network environment 100 is also able to include a precast structure handling system 120 that is able to further include various mechanical members, such as a horizontal structure 122, two vertically parallel members 124A and 124B (collectively referred to as vertically parallel members 124), and two adjustable gripper units 126A and 126B (collectively referred to as adjustable gripper units 126). The network environment 100 is also able to include a power system 130, a vacuum system 140, and a control system 150. The control system 150 are able to further include a control unit 152 and a portable control module 154. All the systems, such as the lifting system 110, the precast structure handling system 120, the power system 130, the vacuum system 140, and the control system 150, in conjunction with each other, are able to provide an optimal handling of a precast structure 160. In some embodiments, various software modules in the network environment 100 are able to be communicatively coupled with each other using a communication network 170.

The lifting system 110 is able to be a construction equipment that is utilized for lifting various kinds of loads and moving them from one place to the other. The lifting system 110 is able to be categorized into two main categories: static lifting system and mobile lifting system. A static lifting system is a permanent/semi-permanent structure fixed to the ground or building that lifts and moves loads along a fixed path. A mobile lifting system is mounted on treads or wheels and is able to be moved from job site to job site. In some embodiments of the present disclosure, the lifting system 110 is able to be operable to lift the precast structure handling system 120 from one location and move the precast structure handling system 120 to another location at the same construction site. Various examples of the lifting system 110 are able to include mobile cranes, vehicle mounted cranes, rough terrain cranes, all terrain cranes, crawler cranes, railroad cranes, aerial cranes, tower cranes, telescopic cranes, overhead cranes, loader cranes, and floating cranes.

The controller 112 is able to include a processor, such as a microcomputer, a microcontroller, a microprocessor, a programmable logic controller (PLC), a programmable gate array (FPGA) or a state machine. The controller 112 is able to receive a plurality of inputs, process the inputs (for example, according to installed logic such as an executable software code running on a processor) and communicate outputs to various elements, such as, including but not limited to, actuators and subsystems that operate the lifting system 110. Inputs to the controller 112 are able to include signals from an operator interface (not shown) and sensor inputs relative to one or more states of elements and/or subsystems of the lifting system 110. Outputs from the controller 112 are able to include control signals for controlling the mobility mechanism 114 of the lifting system 110. Outputs from the controller 112 are further able to include control signals for changing an operating state (for example, speed, torque, and the like) of an actuator, such as, including, but not limited to, motors, pumps, cylinders, valves, switches, and relays of the lifting system 110. In some embodiments, the control signals are further able to control power supply to other systems, such as the power system 130 and the vacuum system 140. Control signals are able to be of any suitable analog or digital communication protocol, for example, pulse width modulation (PWM) type signals or the like.

The mobility mechanism 114 is able to include components that provide a multi-directional mobility to the lifting system 110. The mobility mechanism 114 is able to be combination of a hoist, a trolley, and a bridge girder/jib. The hoist lifts and lowers the precast structure handling system 120 in a vertical plane. The hoist is able to be connected to the trolley that moves back and forth across the bridge girder/jib. The trolley moves the hoist along the bridge girder/jib of the lifting system 110. The hoist is able to be moved horizontally along the top or underside of the bridge girder/jib to position the hoist above the precast structure handling system 120. In some embodiments, the mobility mechanism 114 of the lifting system 110 is also able to be controlled by the control signals generated by the controller 112.

The lifting system sensors 116 are able to include multiple sensing devices, such as tensiometers, force transducers, length and angle sensors, outrigger load sensors, wheel speed sensors, incremental encoders, and hydraulic pressure sensors, involved in safely lifting and transporting the load, for example, the precast structure 160. Networked data from the lifting system sensors 116 and other sensing devices is able to be used by the controller 112 to compute safe operating zones to avoid a maximum load from exceeding a critical angle and distance.

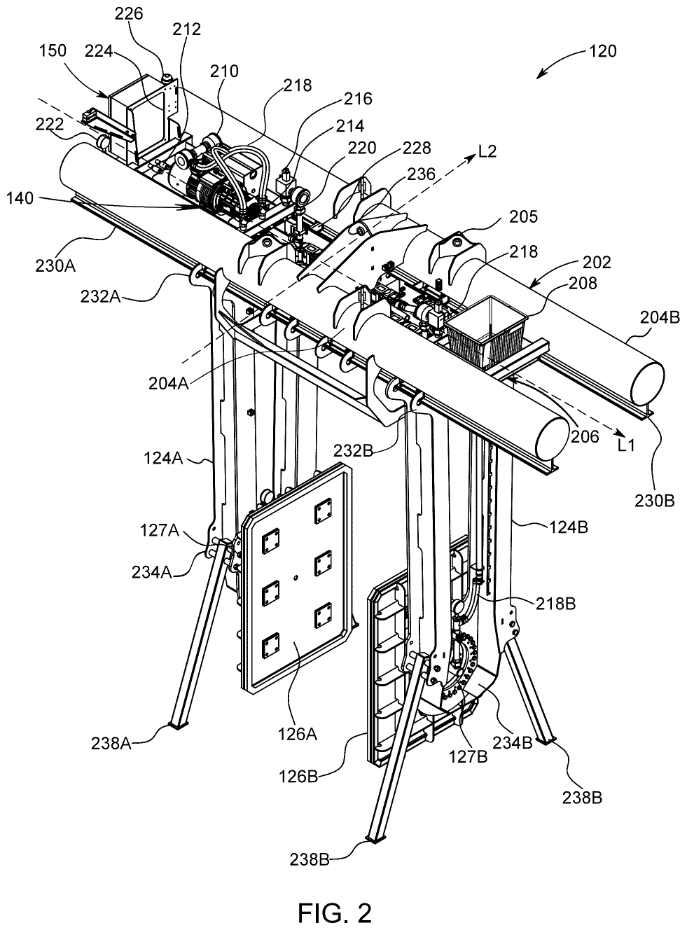

The precast structure handling system 120 is able to be a mechanical structure that is able to be operable to optimally handle various types of precast structures based on the properties of the precast structures. The properties of the precast structures are able to include, for example, a type of precast structure, wall dimensions (length, thickness, height), material composition of the wall, maximum shear force, area and spacing of mesh, number of reinforcement layers, allowable deflection, allowable crack width, maximum reaction at lifting point, tension capacity, allowable rupture stress, actual tensile stress, and the like. For example, the precast structure handling system 120, actuated by the power system 130 and the vacuum system 140, is able to lift a volumetric hollow type of precast structure 160 with reinforced concrete and a wall thickness of 2 inches followed by a 180-degree flip to invert the precast structure 160. In some embodiments, the precast structure handling system 120 is able to be integrated with the control system 150 as a single entity. In some embodiments, the precast structure handling system 120 is able to be communicatively coupled with the control system 150 using the communication network 170. In some embodiments, the precast structure handling system 120 is able to be integrated with the power system 130, the vacuum system 140, and the control system 150 to implement a precast structure handling system 120, as described in FIG. 2.

The horizontal structure 122 of the precast structure handling system 120 is able to correspond to at least one horizontal structural component with a longitudinal rail at its bottom. The longitudinal rail is able to be mechanically coupled with top ends of the two vertically parallel members 124A and 124B. The horizontal structure 122 is able to have a receptacle structure that is able to engage with the hoisting mechanism of the lifting system 110. Accordingly, the precast structure handling system 120 is able to be lifted, lowered down and/or moved to another location by the lifting system 110 within the construction site.

The top ends of the two vertically parallel members 124A and 124B, mechanically coupled with the longitudinal rail of the horizontal structure 122, is able to extend down to the bottom ends. At the bottom ends, the two adjustable gripper units 126A and 126B are mechanically coupled thereto. The bottom end of each parallel member is able to be further attached to a pair of legs extending outwards along the plane of the parallel member. Thus, the two pairs of legs provide a stable support to the precast structure handling system 120 while resting on the ground.

The outer surfaces of the two adjustable gripper units 126A and 126B are able to be mechanically coupled with the bottom ends of the two vertically parallel members 124A and 124B. The inner surfaces of the two adjustable gripper units 126A and 126B, that are facing each other, are able to be equipped with suction pads. The suction pads of the two adjustable gripper units 126A and 126B, attached to the power system 130 and the vacuum system 140, are able to be controlled by the control system 150 with a plurality of settings in alignment with properties of the precast structure.

The lifting system sensors 116 are able to include multiple sensing devices, such as hydraulic sensors, vacuum sensors, position sensors, displacement sensors, and the like. For example, hydraulic sensors are able to detect abnormal hydraulic oil temperature, machine vibration or hydraulic pressure variations, vacuum sensors are able to monitor vacuum pressure and leak testing, and displacement sensors are able to measure dimensions of the precast structure 160 before handling the precast structure handling system 120.

The power system 130 is able to correspond to a power source that drives the movement and lifting functions of the precast structure handling system 120. One example of such a power system 130 is able to be a hydraulic system or unit. The hydraulic system is able to include several components that work together to transfer energy from engine to the cylinders. One component is able to be hydraulic fluid located in a hydraulic reservoir which is the medium that transfers the hydraulic power in the power system 130. The hydraulic fluid is able to be a type of hydraulic oil that resists compression and is able to withstand high temperatures and pressures. Next component is able to be a hydraulic pump that pressurizes the hydraulic fluid and creates the flow that powers the power system 130. The hydraulic pump is able to be driven by the engine of the lifting system 110 and is able to be of different types, such as gear, vane, or piston pumps. Further, there are able to be a plurality of control valves that regulate the flow and pressure of the hydraulic fluid in the power system 130. Control valves are able to be operated by a crane operator and of different types, such as directional, pressure, or flow control valves. Another component is able to be hydraulic cylinders that convert hydraulic pressure into linear force, which pushes or pulls the boom and jib to lift or lower the precast structure handling system 120. Hydraulic cylinders are able to consist of a piston, rod, barrel, and seals, which work together to produce the desired movement.

The vacuum system 140 creates a vacuum to enable the adjustable gripper units 126A and 126B of the precast structure handling system 120 to attach to the precast structure 160 being lifted. The vacuum system 140, powered by an electric power source at the lifting system 110, is able to be used to create the vacuum allowing the adjustable gripper units 126A and 126B to seal directly onto the precast structure 160 being lifted. The vacuum system 140 is able to include a vacuum control device and a vacuum pump. When suction pads, located at the adjustable gripper units 126A and 126B, touch the surface of the precast structure 160 while the vacuum pump is activated, an airtight seal is formed. This is able to cause the vacuum level to increase until the precast structure 160 is secure and is able to be gripped and lifted confidently and safely throughout the handling process. The vacuum level is able to be optimally controlled by the vacuum control device in real-time.

The control system 150 is able to include a suitable logic, circuitry, and interfaces that are able to be configured to serve for remote-controlled operations of the precast structure handling system 120 by using the control unit 152 and a portable control module 154. The control system 150 is able to receive sensor data and/or manual data via signal inputs regarding the precast structure 160 to be handled. In some embodiments, the sensor data is able to be received from IoT devices at the construction site and/or in the factory setting. In some embodiments, the sensor data is able to be received from dedicated sensors deployed at the construction site. In some embodiments, the manual data is able to be provided by a user of the precast structure handling system 120 which is able to be further stored in a memory device. The control system 150 is able to further receive commands from the portable control module 154. Based on the received sensor data, data received from the memory and the commands received from the portable control module 154, the control system 150 is able to control various systems, such as the power system 130 and the vacuum system 140, actuating the precast structure handling system 120 for an automated and optimal handling of the precast structure 160. In some embodiments, the control system 150 is able to be integrated with the controller 112 of the lifting system 110. To summarize, networked data from the multiple sensing devices is able to be used by the control system 150 for controlling various systems associated with the precast structure handling system 120.

In some embodiments, the control unit 152 is able to include a memory for storing the instructions, and a processor configured to execute the instructions. Based on the executed instructions, the processor is able to be further configured to perform various operations. The control unit 152 is able to further include a communication interface for transmitting or receiving data via a wireless link or a wired link to or from another communication interface of the portable control module 154. The wireless link is able to send and receive data via a plurality of channels and in a plurality of frequency bands, including in parallel. Similarly, the portable control module 154 is able to include another memory for storing the instructions and another processor configured to execute the instructions. Based on the executed instructions, the processor is able to be further configured to perform various operations, for example, calculating graphical data for display on a display unit. The portable control module 154 is also able to include another communication interface for transmitting or receiving data via a wireless link or a wired link to or from the communication interface of the control unit 152. The portable control module 154 is also able to include an input/output (I/O) device that is able to enable a user to input data by various means, such as actuator switches, touch screen, keypad, and the line. A power storage device is also provided at the portable control module 154, by way of example, in the form of a rechargeable battery.

The precast structure 160 is able to correspond to a building module prefabricated at a factory under factory scaling, repeatability, and in-factory conditions. The precast structure 160 is able to be then delivered to a construction site for an expeditious on-site assembly. The walls of the precast structure 160 are lightweight due to less material requirements, are faster to make, and have better performance. Apart from the construction sector, various examples of the precast structure 160 are able to extend to manufacturing or packaging sites, as well as warehouses, where volumetric types, such as, big cartons with fragile material, glass cubes, and the like, are required to be handled very efficiently.

In some embodiments of the present disclosure, the precast structure 160 is able to be a hollow prefabricated volumetric structure, such as a bathroom pod, to be installed at the construction site. The hollow prefabricated volumetric structure is able to have fiber reinforced concrete with wall thickness of 2 inches. The strength of the material of the precast structure 160 is able to be such that while being lifted and flipped by the precast structure handling system 120, the precast structure 160 is able to withstand a high pressure of about 2000 psi, without experiencing any cracks or other such damage.

The communication network 170 is able to comprise suitable logic, circuitry, and interfaces that are able to be configured to facilitate communication data to be transmitted and received between different components, systems and/or sub-systems of the network environment 100. The communication data is able to be transmitted or received via at least one communication channel of a plurality of communication channels. The communication channels are able to include, but are not limited to, a wireless channel, a wired channel, or a combination of wireless and wired channel thereof. The wireless or wired channel is able to be associated with a data standard which is able to be defined by one of a Local Area Network (LAN), a Personal Area Network (PAN), a wireless personal LAN (WPLAN), a Wireless Local Area Network (WLAN), a Wireless Sensor Network (WSN), a WAN, and a Wireless Wide Area Network (WWAN), the Internet, cellular networks, Wireless Fidelity (Wi-Fi) networks, short-range networks (for example, Bluetooth®, WiGig, ZWave®, ZigBee®, IrDA, and the like), and/or any other wired or wireless communication networks or mediums. In accordance with some embodiments, the wired channel is able to be selected based on the bandwidth criteria. For example, an optical fiber channel is able to be used for a high bandwidth communication, and a coaxial cable (or Ethernet-based communication channel) is able to be used for moderate bandwidth communication. In accordance with various embodiments, any, some, combination, or all the systems, modules, and/or sub-systems of the network environment 100 are able to be adapted to execute any operating system, such as Linux-based operating systems, UNIX-based operating systems, Microsoft Windows, Windows Server, MacOS, Apple IOS, Google Android, or other customized and/or proprietary operating system.

Although only one precast structure is illustrated herein, it will be apparent to a person with ordinary skill in the art that a building is constructed using multiple precast structures. In some embodiments, each of the aforesaid precast structures of different sizes are independently manufactured in a factory setting and mounted on the construction site using the precast structure handling system 120. For each precast structure 160 illustrated in FIG. 1, settings of the precast structure handling system 120 are able to be automatically adjusted without any deviation from the scope of the disclosure.

FIG. 2 illustrates an isometric view of a precast structure handling system 120 in accordance with some embodiments. As shown in FIG. 2, the precast structure handling system 120 is able to operate in a first configuration. According to the first configuration, the precast structure handling system 120 is able to include the precast structure handling system 120, the power system 130 and the vacuum system 140. In some embodiments, the control system 150 is also able to be integrated with the precast structure handling system 120 to control the power system 130 and the vacuum system 140. In some embodiments, the control system 150 is able to be integrated with the controller 112 of the lifting system to control the power system 130 and the vacuum system 140 in the precast structure handling system 120.

As shown in FIG. 2, there is shown the power system 130, such as a hydraulic system, that is able to serve as a horizontal member 202 for the precast structure handling system 120. The horizontal member 202 is able to include two cylinders 204A and 204B of the power system 130, aligned in a spaced relationship parallel to an imaginary longitudinal axis ‘L1’. The two cylinders 204A and 204B are able to be aligned adjacent to each other such that the longitudinal axis ‘L1’ lies between the longitudinal axis of the two cylinders 204A and 204B in a horizontal plane. The two cylinders 204A and 204B are able to be held together by a defined distance by means of metallic planks, each metallic plank welded with the two cylinders 204A and 204B along a lateral axis ‘L2’, to form a platform 206. Further, claw shaped members 205 also provide additional support to the cylinders 204A and 204B to stay aligned adjacent to each other.

In some embodiments, various systems, such as the power system 130 and the vacuum system 140, are able to be attached to the platform 206. Such systems are able to be connected to various parts of the precast structure handling system 120 for facilitating different operations, such as lifting, lowering, gripping, flipping, and the like. For example, the power system 130 is able to be connected with the two vertically parallel members 124A and 124B and the two adjustable gripper units 126A and 126B and is able to facilitate operations, such as lifting, lowering, and flipping. Further, the vacuum system 140 is able to be connected with the two adjustable gripper units 126A and 126B and is able to facilitate operations, such as activating suction pads for gripping the precast structure 160. In some embodiments of the present disclosure, the power system 130 is able to include a hydraulic power unit 208 that is able to include a motor, a fluid reservoir, and a pump, and works to apply the hydraulic pressure needed to drive motors, the cylinders 204A and 204B, and other complementary parts of the power system 130.

Further, the vacuum system 140 is able to include an air filter with housing 210, a pressure transmitter 212, a non-return valve 214, a vacuum valve 216, vacuum hoses 218, an air filter 220, and a vacuum gauge 222. Apart from the components of the power system 130 and the vacuum system 140, there are shown some additional components as well, such as a wall socket 224, a buzzer 226, and a plastic plate chain suspension 228. All such systems, such as, the power system 130, the vacuum system 140, and the control system 150, are able to be powered by the electrical power source at the lifting system 110 via the wall socket 224.

As shown in FIG. 2, longitudinal rails 230a and 230B, matched for use together, are able to run horizontally at the bottom of the cylinders 204A and 204B, respectively. The purpose of the longitudinal rails 230A and 230B are able to be to guide the vertically parallel members 124A and 124B along a defined path. A normal to the planar structure of each of the vertically parallel members 124A and 124B is able to be parallel to the longitudinal axis ‘L1’. The top ends 232A and 232B of each of the vertically parallel members 124A and 124B are able to be structured into a hook shape for a slidable mechanical coupling of each of the vertically parallel members 124A and 124B with both longitudinal rails 230A and 230B. In some embodiments, the vertically parallel members 124A and 124B are able to slidably move away from each other in case the width of the precast structure 160 is bigger than a current distance between the vertically parallel members 124A and 124B. In some embodiments, the vertically parallel members 124A and 124B are able to slidably move towards each other in case the width of the precast structure 160 is smaller than a current distance between the vertically parallel members 124A and 124B. In some embodiments, the movement of the vertically parallel members 124A and 124B are able to be either controlled automatically by the control unit 152 based on the sensor data or controlled remotely by use of the portable control module 154 by means of manipulating one or more hardware or software buttons, or via voice-based commands.

The bottom ends 234A and 234B of the vertically parallel members 124A and 124B, respectively, are able to be attached with the two adjustable gripper units 126A and 126B, respectively. In some embodiments, the vertically parallel members 124A and 124B are able to be attached with the two adjustable gripper units 126A and 126B, using swivel coupling mechanisms 127A and 127B. The swivel coupling mechanisms 127A and 127B are able to enable the two adjustable gripper units 126A and 126B, respectively, to rotate by 180 degree clockwise or anticlockwise. However, it should be understood that apart from the swivel coupling mechanisms 127A and 127B, any other type of mechanical coupling, which is able to allow the two adjustable gripper units 126A and 126B to pivot freely, is also able to be possible, without any deviation from the scope of the disclosure.

In some embodiments, the two adjustable gripper units 126A and 126B are able to be further connected to the power system 130, the vacuum system 140, and the control system 150. The power system 130 in conjunction with the control system 150 is able to enable the two adjustable gripper units 126A and 126B to finely adjust by a second calibrated movement according to the width between the outer surfaces of the opposite walls of the precast structure 160. The second calibrated movement is able to be based on the received precast structure data and is able to cause the two adjustable gripper units 126A and 126B to abut against the outer surfaces of the opposite walls of the precast structure 160. At this position, the vacuum system 140 in conjunction with the control system 150 is able to enable the two adjustable gripper units 126A and 126B to firmly grip the precast structure 160. Once firmly gripped, the lifting system 110 is able to lift the precast structure handling system 120 by engaging its hoisting mechanism with the receptacle structure 236 of the precast structure handling system 120. Once lifted above the ground at a clearance level, the power system 130 in conjunction with the control system 150 is able to activate the swivel coupling mechanisms 127A and 127B such that the two adjustable gripper units 126A and 126B rotate by, for example 180 degrees, and flip the precast structure 160 without causing any damage.

As further shown in FIG. 2, the bottom ends 234A and 234B of the vertically parallel members 124A and 124B are able to be further attached to two pairs of legs 238A and 238B, respectively. The pairs of legs 238A and 238B are able to extend outwards along the plane of the vertically parallel members 124A and 124B, respectively, and provide a stable support to the precast structure handling system 120 while resting on the ground.

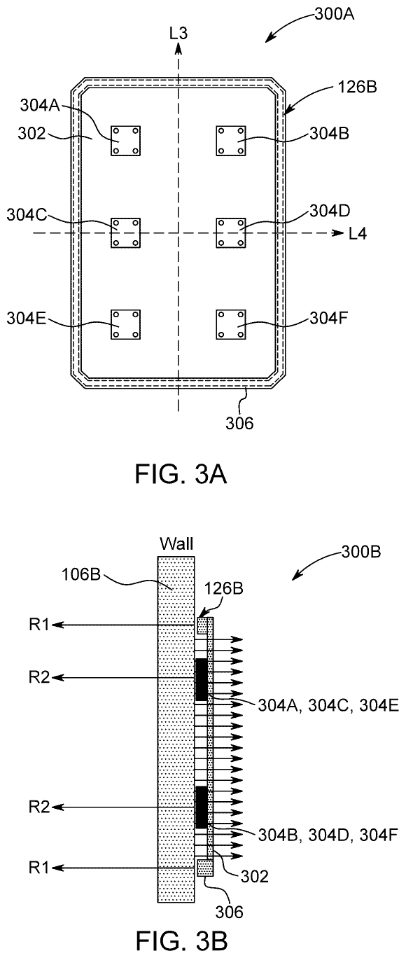

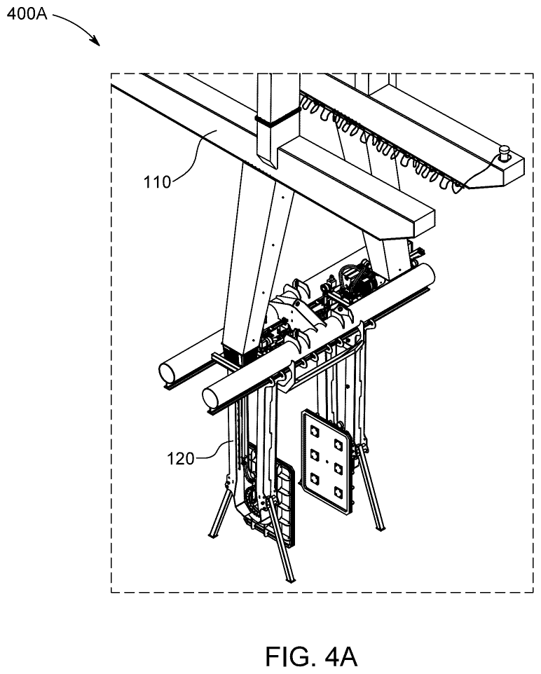

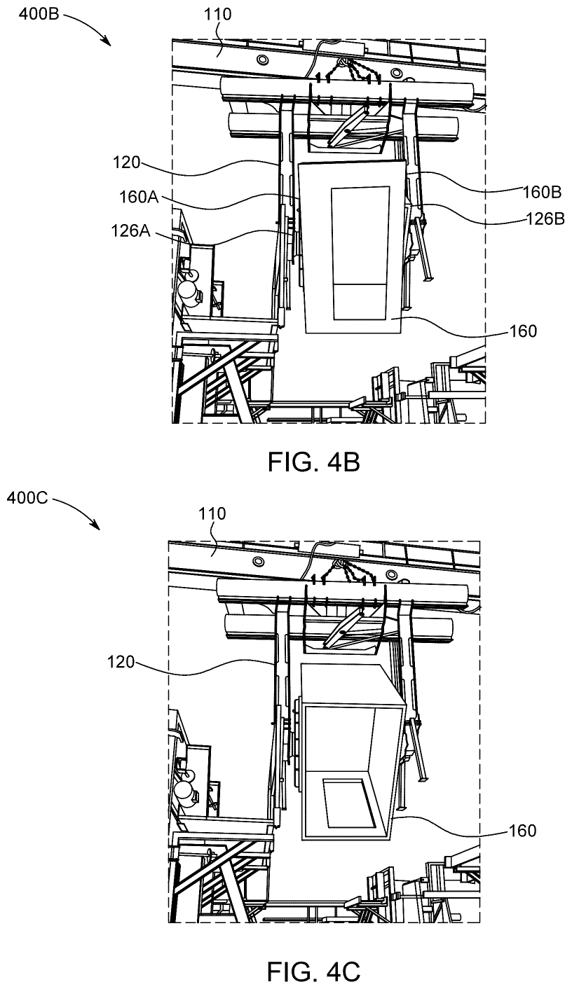

FIGS. 3A and 3B illustrate different views of suction pads of an adjustable gripper unit, in accordance with some embodiments. More specifically, FIG. 3A illustrates a front view 300A and FIG. 3B illustrates a top view 300B of the adjustable gripper unit 126B. Referring back to FIG. 2, the adjustable gripper unit 126B is able to be connected to the vacuum system 140 through a vacuum hose 218B. The vacuum hose 218B is able to allow an airflow generated by the vacuum system 140 and direct the airflow to the adjustable gripper unit 126B. Accordingly, the vacuum system 140 is able to provide lifting power to the adjustable gripper unit 126B. With vacuum lifting, an out of plane pressure on a wall 106B (FIG. 4B) of the precast structure 160 is able to be observed.

As shown in FIG. 3A, the adjustable gripper unit 126B is able to include a suction pad 302 and a plurality of friction pads 304, such as friction pads 304A, . . . , 304F, affixed at a surface of the suction pad 302. The adjustable gripper unit 126B is further able to include a resilient member 306 running along a boundary of the suction pad 302.

The suction pad 302 is able to correspond to an engaging surface that is able to enable the adjustable gripper unit 126B to firmly grip the precast structure 160 during various operations, such as lifting, lowering, flipping, and the like. A central portion of the suction pad 302 is able to be provided with a suction port 302A. A suction surface of the suction pad 302 is able to be a flexible material, such as rubber vulcanized with metal or plastic, that is able to be attached to the vacuum system 140. When the vacuum pressure is applied through the suction port 302A, the flexible material of the suction pad 302 conforms to the surface of the precast structure 160 being lifted, creating a secure seal. The precast structure 160 is then held in place by the vacuum pressure, allowing the precast structure to be safely lifted and transported. The amount of vacuum pressure used is able to be adjusted to accommodate different weights and sizes of the precast structure 160, and the flexible material of the suction pad 302 is able to be designed to adapt to different shapes and surface contours for a more secure grip.

In some embodiments, as shown in FIG. 3A, the outer and the inner dimensions of the suction pad 302 are able to be 1100×1600 mm and 1000×1500 mm, respectively, with chamfered edges. When fully vacuumized by 100%, the pressure is able to be-1 bar, which is 100 kN/m². The inner dimension of 1000×1500 mm of the suction pad 302 is able to lead to a total load of 150 kN per suction pad. However, it should be noted that the above dimensions and shape are for exemplary purposes only and should not be construed to limit the scope of the disclosure.

The plurality of friction pads 304 are able to be affixed at the top of the suction pad 302 and are able to have, for example, an Ethylene propylene diene monomer (EDPM) rubber lip or a foam-rubber gasket. The plurality of friction pads 304 are able to act to adhere to the outer surface of the precast structure 160, particularly when negative pressure exists in the suction pad 302 such that the plurality of friction pads 304 do not move along the outer surface of the precast structure 160, and thereby maintain the negative pressure in the suction area which generates the suction seal against the outer surface of the precast structure 160.

In some embodiments, as shown in FIG. 3A, the dimensions of each of the plurality of friction pads 304 are able to be 150×150 mm and symmetrically distributed over the surface of the suction pad 302. For example, the distance of centroids of the friction pads 304A, 304C, and 304E is at 275 mm towards one side of the longitudinal axis ‘L3’ that is passing from the centroid of the suction pad 302. Similarly, the distance of centroids of the friction pads 304B, 304D, and 304F is also at 275 mm towards opposite side of the longitudinal axis ‘L3’. Laterally, the centroids of friction pads 304C and 304D lie on the lateral axis ‘L4’ passing from the centroid of the suction pad 302 and is orthogonal to the longitudinal axis ‘L3’. Also, the distance of the centroids of friction pads 304A and 304B is at 475 mm towards one side of the longitudinal axis ‘L3’. Similarly, the distance of the centroids of friction pads 304E and 304F is also at 475 mm towards opposite side of the longitudinal axis ‘L3’. However, it should be noted that the above dimensions are for exemplary purposes and should not be construed to limit the scope of the disclosure.

The resilient member 306 is able to correspond to a flexible or elastic lip made of rubber or the like, providing an air-tight closure against the surface of the precast structure 160, while the precast structure 160 is gripped firmly by the adjustable gripper unit 126B. In some embodiments, the height of the resilient member 306, which is transversal to a plane of the suction pad 302, is able to be substantially greater than the height of the plurality of friction pads 304. In some embodiments, as shown in FIG. 3A, the width of the resilient member 306 is able to be 100 mm that runs along the edges of the suction pad 302. However, it should be noted that the above dimensions are for exemplary purposes and should not be construed to limit the scope of the disclosure.

As shown in FIG. 3B, as the adjustable gripper unit 126B abuts against the outer surface 160B of the wall of the precast structure 160, and the vacuum system 140 activates the suction of the suction pad 302, the suction load, such as, the precast structure 160, leads to a reaction force in the resilient member 306, illustrated by ‘R1’. An average value of such reaction force can be of the order of 30 kN per meter. Further, a part of such load is able to be borne by the plurality of friction pads 304, illustrated by ‘R2’. The exact load distribution between ‘R1’ and ‘R2’ is able to depend on flexibility of the resilient member 306.

It should be noted that for brevity, the structure and working of only the adjustable gripper unit 126B has been illustrated and described in FIGS. 3A and 3B. It should be further noted that the structure and working of the adjustable gripper unit 126A is similar to the adjustable gripper unit 126B, without any deviation from the scope of the disclosure.

FIGS. 4A to 4C illustrate various views while the precast structure handling system 120 is handling the precast structure 160, in accordance with some embodiments. A first view 400A in FIG. 4A illustrates the precast structure handling system 120 at rest. In such a state, the two pairs of legs 238A and 238B provide a stable support to the precast structure handling system 120 while resting on the ground. A second view 400B in FIG. 4B illustrates the two adjustable gripper units 126A and 126B of the precast structure handling system 120, in conjunction with the power system 130, the vacuum system 140, and the control system 150, firmly gripping the precast structure 160. Once firmly gripped, the lifting system 110 is able to lift the precast structure handling system 120 by engaging its hoisting mechanism with the receptacle structure 236 of the precast structure handling system 120. A third view 400C in FIG. 4C illustrates the two adjustable gripper units 126A and 126B of the precast structure handling system 120, in conjunction with the power system 130, the vacuum system 140, and the control system 150, rotating the firmly gripped precast structure 160 by 180 degrees once the precast structure 160 is lifted above the ground at a clearance level.

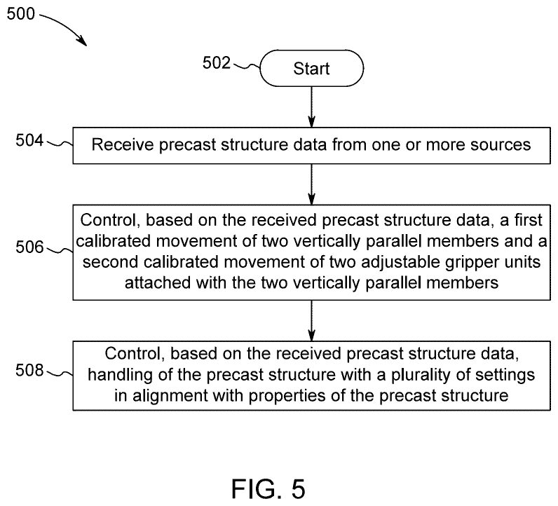

FIG. 5 illustrates a flowchart specifying the steps of a method 500 for handling a precast structure, in accordance with some embodiments.

Although specific operations are disclosed in FIG. 5, such operations are examples and are non-limiting. In different embodiments, to name only a few examples, the method 500 includes other steps, the sequence of the steps is modified, some steps are omitted, or any combination of these variations are able to be incorporated. The steps of the method 500 are able to be automated or semi-automated. In various embodiments, one or more of the operations of the method 500 are able to be controlled or managed by software, by firmware, by hardware, or by any combination thereof, but is not limited to such. Further, FIG. 5 will be explained in conjunction with the descriptions of FIGS. 1 to 4C.

Referring to FIG. 5, the method 500 includes processes in accordance with the present disclosure which are able to be controlled or managed by a processor(s) and electrical components under the control of a computer or computing device comprising computer-readable media containing computer-executable instructions or code. The readable and executable instructions (or code) are able to reside, for example, in data storage such as volatile memory, non-volatile memory, and/or mass data storage, as only some examples. As explained later, in some embodiments, automation of the method 500 through a computer employs various peripherals such as sensors, robotic arms, etc.

Referring to FIG. 5, at step 502, the method 500 includes receiving precast structure data from one or more sources. The precast structure data is able to be received by the control system 150 from one or more sources, such as the equipment sensors 128, the lifting system sensors 116, memory of the control system 150 or the controller 112, manual input provided by the user handling the portable control module 154, the controller 112 of the lifting system 110, and the like. The precast structure data is able to include details about the dimensions of the precast structure 160, type of material and load of the precast structure 160, and the like. In some embodiments, based on the received precast structure data, the processor of the control system 150 is able to calculate other parameters, such as characteristic of the current lifting load situation, position and/or the permissibility of work processes on the lifting system 110.

At step 504, the method 500 includes controlling, based on the received precast structure data, a first calibrated movement of two vertically parallel members 124A and 124B and a second calibrated movement of two adjustable gripper units 126A and 126B attached with the two vertically parallel members 124A and 124B. Based on the received precast structure data, the processor of the control system 150 is able to determine a first calibrated movement for the two vertically parallel members 124A and 124B, and a second calibrated movement for the two adjustable gripper units 126A and 126B. The control system 150, in conjunction with the power system 130, is able to control the first calibrated movement of two vertically parallel members 124A and 124B and the second calibrated movement of two adjustable gripper units 126A and 126B.

In some embodiments, the first calibrated movement is able to correspond to a first mutual displacement value that is able to be required by the two vertically parallel members 124A and 124B to suitably adjust in accordance with the width of the precast structure 160 to be lifted. Said differently, the two vertically parallel members 124A and 124B are able to be required to expand or collapse by sliding on the longitudinal rails 230A and 230B of the horizontal member 202 based on the width of the precast structure 160. Such first mutual displacement is able to be a value that exceeds a threshold value defined by the control system 150. For example, the first mutual displacement is able to be of the order of inches, feet, or higher magnitude.

In some embodiments, the second calibrated movement is able to correspond to a second mutual displacement value that is able to be required by the two adjustable gripper units 126A and 126B to suitably adjust in accordance with the width of the precast structure 160 to be lifted. Said differently, the two adjustable gripper units 126A and 126B are able to be required to expand or collapse based on the width of the precast structure 160. Such second mutual displacement is able to be a value that is less than the threshold value defined by the control system 150. For example, the second mutual displacement is able to be of the order of cm, mm, or lower magnitude.

Based on the first calibrated movement and the second calibrated movement, the adjustable gripper units 126A and 126B abut the respective outer surfaces 160A and 160B of the opposite walls of the precast structure 160. At this time, the vacuum system 140 is able to be activated and the adjustable gripper units 126A and 126B firmly grips the precast structure 160.

At step 506, the method 500 includes controlling, based on the received precast structure data, handling of the precast structure 160 with a plurality of settings in alignment with properties of the precast structure 160. Based on the received precast structure data, the control system 150, in conjunction with the power system 130 and the vacuum system 140, is able to handle the precast structure 160 with a plurality of settings in alignment with properties of the precast structure 160.

For example, in some embodiments, the lifting system 110 is able to lift the precast structure handling system 120 from the ground at a clearance level by engaging its hoisting mechanism with the receptacle structure 236 of the precast structure handling system 120. The power system 130 in conjunction with the control system 150 is able to lift up the two adjustable gripper units 126A and 126B with the firmly gripped precast structure 160 along a guiding track provided at the vertically parallel members 124A and 124B, in accordance with a first setting.

Further, the power system 130 in conjunction with the control system 150 is able to activate the swivel coupling mechanisms 127A and 127B such that the two adjustable gripper units 126A and 126B rotate by, for example 180 degrees, and flip the precast structure 160, in accordance with a second setting. Such plurality of settings is in alignment with properties of the precast structure 160 such that even at a high load level, for example 2000 pounds, the precast structure 160 with thin walls, for example 2 inches thin walls, is able to be optimally handled (lifted and flipped as well), without causing any damage to the precast structure 160.

Thereafter, using the trolley and the bridge girder/jib, the lifting system 110 is able to relocate the precast structure handling system 120 to a desired location, lowered, and placed at a desired position by deactivating the vacuum system 140.

In some embodiments, a system (e.g., a computer) for performing the steps of the method 500 is automated. In some embodiments, the computer includes a memory storing computer-executable instructions that when executed by a processor perform the steps of method 500.

The terms “comprising,” “including,” and “having,” as used in the specification herein, shall be considered as indicating an open group that is able to include other elements not specified. The terms “a,” “an,” and the singular forms of words shall be taken to include the plural form of the same words, such that the terms mean that one or more of something is provided. The term “one” or “single” is able to be used to indicate that one and only one of something is intended. Similarly, other specific integer values, such as “two,” are able to be used when a specific number of things is intended. The terms “preferably,” “preferred,” “prefer,” “optionally,” “may,” and similar terms are used to indicate that an item, condition, or step being referred to is an optional (not required) feature of the presently claimed invention. The term “connecting” includes connecting, either directly or indirectly, and “coupling,” including through intermediate elements.

The presently claimed invention has been described with reference to various specific and preferred embodiments and techniques. However, it should be understood that many variations and modifications are able to be made while remaining within the spirit and scope of the invention. It will be apparent to one of ordinary skill in the art that methods, devices, device elements, materials, procedures, and techniques other than those specifically described herein are able to be applied to the practice of the invention as broadly disclosed herein without resort to undue experimentation. All art-known functional equivalents of methods, devices, device elements, materials, procedures, and techniques described herein are intended to be encompassed by this presently claimed invention. Whenever a range is disclosed, all subranges and individual values are intended to be encompassed. This presently claimed invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the presently claimed invention has been described with respect to a limited number of embodiments, those skilled in the art, having benefit of this disclosure, will appreciate that other embodiments can be devised which do not depart from the spirit and scope of the invention as disclosed herein.

We claim:

1. A precast structure handling system, comprising:
at least two vertically parallel members having top ends and bottom ends, the top ends are configured for mechanically coupling with a longitudinal rail at a bottom of a horizontal member;
at least two adjustable gripper units coupled with opposite bottom ends of the at least two vertically parallel members, each adjustable gripper unit comprising a suction pad configured for coupling with a surface of a precast structure based on a pressure difference generated by a vacuum system; and
a control system configured for controlling a plurality of systems to handle the precast structure based on a plurality of settings in alignment with properties of the precast structure.

2. The precast structure handling system according to claim 1, wherein the plurality of systems comprises at least the vacuum system and a power system configured for handling the precast structure,
wherein the vacuum system is driven by a controller of a lifting system.

3. The precast structure handling system according to claim 2, wherein the at least two adjustable gripper units are controlled by the power system based on a width of the precast structure.

4. The precast structure handling system according to claim 2, wherein a rotation of the at least two adjustable gripper units is controlled by the power system at a defined angular rotation.

5. The precast structure handling system according to claim 2, wherein the at least two vertically parallel members are controlled by the power system to slidably adjust along the longitudinal rail at the bottom of the horizontal member.

6. The precast structure handling system according to claim 1, wherein the at least two adjustable gripper units are adaptable to bear a load of the precast structure,
wherein a first part of the load is borne by a plurality of friction pads affixed at a surface of the suction pad of each adjustable gripper unit,
wherein a second part of the load is borne by a resilient member running along a boundary of the suction pad of each adjustable gripper unit, and
wherein a load distribution between the plurality of friction pads and the resilient member is based on an elasticity factor of the resilient member.

7. The precast structure handling system according to claim 6, wherein a first height of the resilient member that is transversal to a plane of the suction pad is substantially greater than a second height of the plurality of friction pads.

8. The precast structure handling system according to claim 1, wherein the precast structure corresponds to a hollow prefabricated volumetric structure.

9. The precast structure handling system according to claim 8, wherein the hollow prefabricated volumetric structure is made of fiber reinforced concrete.

10. The precast structure handling system according to claim 1, wherein the control system is further configured to:
receive precast structure data from one or more sources; and
control, based on the received precast structure data, the at least two vertically parallel members to slidably adjust towards each other by a first calibrated movement along the longitudinal rail according to a width between outer surfaces of opposite walls of the precast structure.

11. The precast structure handling system according to claim 10, wherein the control system is further configured to control, based on the received precast structure data, the at least two adjustable gripper units to finely adjust by a second calibrated movement according to the width between the outer surfaces of the opposite walls of the precast structure.

12. A precast structure handling method, comprising:
receiving, by a control system, precast structure data from one or more sources;
controlling, by the control system and based on the precast structure data, a first calibrated movement of at least two vertically parallel members and a second calibrated movement of at least two adjustable gripper units attached with the at least two vertically parallel members; and
controlling, by the control system and based on the precast structure data, handling of a precast structure with a plurality of settings in alignment with properties of the precast structure.

13. The precast structure handling method according to claim 12, wherein a load distribution of the precast structure between a plurality of friction pads and a resilient member at the at least two adjustable gripper units is based on an elasticity factor of the resilient member.

14. The precast structure handling method according to claim 13, wherein a first part of a load of the precast structure is borne by the plurality of friction pads at the at least two adjustable gripper units, and
wherein a second part of the load is borne by the resilient member at the at least two adjustable gripper units.

15. The precast structure handling method according to claim 13, wherein a first height of the resilient member that is transversal to a plane of the suction pad is substantially greater than a second height of the plurality of friction pads.

16. The precast structure handling method according to claim 12, further comprises controlling, by the control system, the second calibrated movement of the at least two adjustable gripper units based on a width of the precast structure.

17. The precast structure handling method according to claim 12, wherein the handling of the precast structure includes lifting or lowering of the precast structure gripped by the at least two adjustable gripper units of a precast structure handling system.

18. The precast structure handling method according to claim 12, wherein the handling of the precast structure includes rotation of the precast structure gripped by the at least two adjustable gripper units at a defined angular rotation.

19. The precast structure handling method according to claim 12, wherein the precast structure corresponds to a hollow prefabricated volumetric structure,
wherein the hollow prefabricated volumetric structure is made of fiber reinforced concrete.

20. The precast structure handling method according to claim 12, further comprising controlling, by the control system, the precast structure handling system, the power system connected to the precast structure handling system, and a vacuum system attached with the at least two adjustable gripper units.
